(19) United States
(12) Patent Application Publication
(10) Pub. No.: US 2012/0303654 A1
(43) Pub. Date: Nov. 29, 2012

(54) METHODS AND SYSTEMS TO AUTOMATICALLY EXTRACT AND TRANSPORT DATA ASSOCIATED WITH WORKLOAD MIGRATIONS TO CLOUD NETWORKS

(76) Inventor: James Michael FERRIS, Cary, NC (US)

(21) Appl. No.: 13/116,599

(22) Filed: May 26, 2011

(51) Int. Cl. G06F 17/30

(52) U.S. Cl. 707/769; 707/827; 707/E17.014; 707/E17.032

(57) ABSTRACT

A data migration tool can automatically locate or discover data that is being used by, or associated with, workloads being re-located to or within a cloud network. The data migration tool can automatically initiate the transport of that data to the cloud, and store the data in the cloud so that it is associated with the migrated workloads.

### FIELD

This invention relates generally to products and services, more particularly, to systems and methods for cloud computing related services and products.

### DESCRIPTION OF THE RELATED ART

The advent of cloud-based computing architectures has opened new possibilities for the rapid and scalable deployment of virtual Web stores, media outlets, and other on-line sites or services. In general, a cloud-based architecture deploys computing resources such as processors, operating systems, software and other components that can be combined or strung together in an abstract structure or “cloud network” to form and support virtual machines. A user or customer can request the instantiation of a virtual machine or set of virtual machines from those resources from a central server or management system to perform intended tasks or applications. For example, a user may wish to set-up and instantiate a virtual server from the cloud network to create a storefront to market products or services on a temporary basis, for instance, to sell tickets to an upcoming sports or musical performance. The user can lease or subscribe to the computing resources needed to build and run the virtual machines on a comparatively short-term basis, such as hours or days, for their intended application. Likewise, a user can utilize a cloud-based architecture to form a cloud network on existing computing resources owned by the user.

In addition to starting new virtual machines in a cloud network, existing software applications, software appliances, virtual machines, etc., can be migrated from a physical network to a cloud network or can be migrated between cloud networks. When migrating an existing workload, e.g. software application, software appliances, virtual machines, etc., into a cloud network or between cloud networks, it is not easy to migrate data associated with the existing workload. For example, a user can specify details of the workload to be migrated (e.g. specific software application to migrate), but the extraction and migration of data associated with the workload may or may not be supported, requiring the user to manually or separately locate, extract, and transport the data associated with existing workload deployed to cloud network. This often includes physically copying the data to media and transferring the media to the operator of the cloud network. Additionally, the extraction and migration of data requires significant user interaction. For example, the user must identify the data associated with a workload, identify the location of the data, extract the data from the existing network, whether physical or cloud network based, and provide the data to the operator of the cloud network. Further, to ensure that migrated workloads operate properly, the user must ensure that the correct data and all the data is migrated and associated with the migrated workloads. Thus, no mechanism exists to easily and efficiently identify and migrate data associated with workloads being migrated into a cloud.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 illustrates an example of a cloud computing environment in which various embodiments of the present teachings can be practiced;

FIG. 2 illustrates another example of the cloud computing environment in which various embodiments of the present teachings can be practiced in another regard including multiple cloud arrangements, according to various embodiments;

FIGS. 3-5 illustrate various examples of the cloud computing environment in which a data migration tool can identify, extract, and migrate data that is associated with migrated workloads, according to various embodiments;

FIG. 6 illustrates an exemplary hardware configuration for a computing system supporting the data migration tool, according to various embodiments; and

FIG. 7 illustrates a flowchart of an exemplary process for identifying and migrating data for workloads being migrated in a cloud computing environment, according to various embodiments.

### DETAILED DESCRIPTION OF EMBODIMENTS

For simplicity and illustrative purposes, the principles of the present teachings are described by referring mainly to exemplary embodiments thereof. However, one of ordinary skill in the art would readily recognize that the same principles are equally applicable to, and can be implemented in, all types of information and systems, and that any such variations do not depart from the true spirit and scope of the present teachings. Moreover, in the following detailed description, references are made to the accompanying figures, which illustrate specific embodiments. Electrical, mechanical, logical and structural changes may be made to the embodiments without departing from the spirit and scope of the present teachings. The following detailed description is, therefore, not to be taken in a limiting sense and the scope of the present teachings is defined by the appended claims and their equivalents.

Embodiments of the present teachings relate to systems and methods for automatically identifying and migrating data associated with workloads being migrated in a cloud computing environment. According to embodiments, a data migration tool can automatically locate or discover data that is being used by, or associated with, workloads being re-located to or within a cloud network. The data migration tool can automatically initiate the transport of that data to the cloud, and store the data in the cloud so that it is associated with the migrated workloads.

By automatically identifying and migrating data, users of the cloud can migrate and begin to operate in the cloud, and seamlessly access the same data they have been working on, prior to migration, without a need to separately specify the names or locations of working files, directories, or databases. Accordingly, the data migration tool allows the user flexibility in using the cloud and migrating to new clouds without the worry of maintaining data consistency.

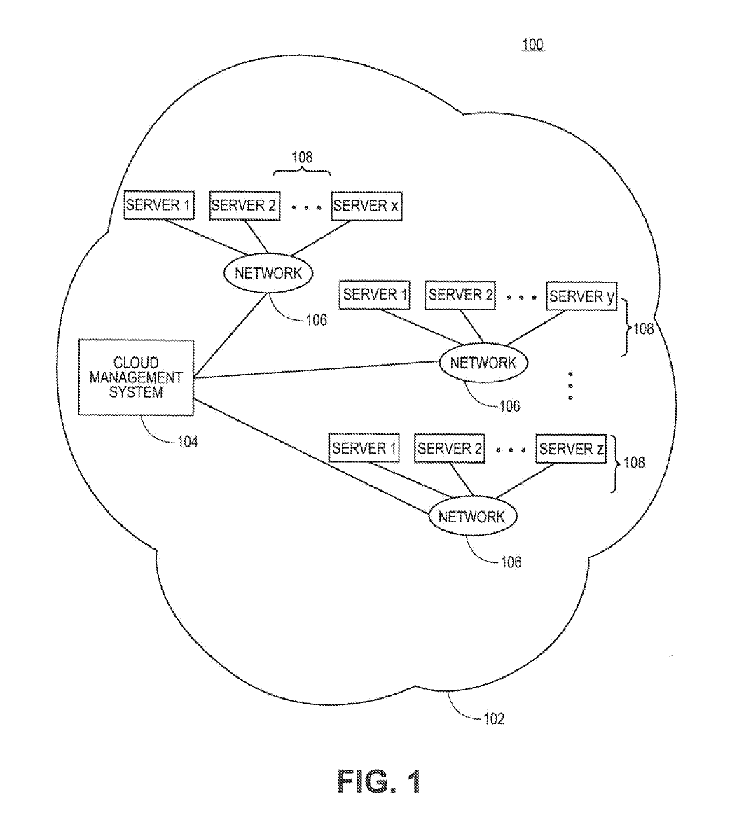

FIG. 1 illustrates an overall cloud computing environment 100 in which software from different vendors can be provided in a cloud, and systems and methods for identifying compatible software, provided by the different vendors, in the cloud, according to embodiments of the present teachings. As used herein, a “cloud” can comprise a collection of resources that can be invoked to instantiate a virtual machine, software appliance or other process for a limited or defined duration. As shown for example in FIG. 1, the collection of resources supporting a cloud 102 can comprise resource servers 108 configured to deliver computing components needed to instantiate a virtual machine, software appliance, or other process. For example, one group of the resource servers 108 can host and serve an operating system or components thereof to deliver to and instantiate a virtual machine. Another group of the resource servers 108 can accept requests to host computing cycles or processor time, to supply a defined level of processing power for a virtual machine. A further group of the resource servers 108 can host and serve applications to load on an instantiation of a virtual machine, such as an email client, a browser application, a messaging application, or other applications or software. Other types of resource servers are possible.

In embodiments, the entire set of the resource servers 108 or other hardware or software resources used to support the cloud 102 along with its instantiated virtual machines, software appliances, or other processes can be managed by a cloud management system 104. The cloud management system 104 can comprise a dedicated or centralized server and/or other software, hardware, and network tools that communicate via one or more networks 106 such as the Internet or other public or private network with all of the resource servers 108 to manage the cloud 102 and its operation. To instantiate a new virtual machines, software appliances, or other processes, a user can transmit an instantiation request to the cloud management system 104 for the particular type of virtual machine, software appliance, or other process they wish to invoke for their intended application. A user can for instance make a request to instantiate a set of virtual machines configured for email, messaging or other applications from the cloud 102. The request can be received and processed by the cloud management system 104, which identifies the type of virtual machine, software appliance, or other process being requested. The cloud management system 104 can then identify the collection of resources necessary to instantiate that virtual machine, software appliance, or other process. In embodiments, the instantiated virtual machines, software appliances, or other processes can, for example, comprise virtual transaction servers used to support Web storefronts, or other transaction sites.

In embodiments, the user's instantiation request can specify a variety of parameters defining the operation of the virtual machines, software appliances, or other processes to be invoked. The instantiation request, for example, can specify a defined period of time for which the instantiated virtual machine, software appliance, or other process is needed. The period of time can be, for example, an hour, a day, or other increment of time. In embodiments, the user's instantiation request can specify the instantiation of the virtual machines, software appliances, or other processes on a task basis, rather than for a predetermined amount of time. For instance, a user could request resources until a software update is completed. The user's instantiation request can specify other parameters that define the configuration and operation of the virtual machines, software appliances, or other processes. For example, the request can specify an amount of processing power or input/output (I/O) throughput the user wishes to be available to each instance of the virtual machines, software appliances, or other processes. In embodiments, the requesting user can for instance specify a service level agreement (SLA) acceptable for the virtual machines, software appliances, or other processes. Other parameters and settings can be used. One skilled in the art will realize that the user's request can likewise include combinations of the foregoing exemplary parameters, and others.

When the request to instantiate a virtual machines, software appliances, or other processes has been received and the necessary resources to build the virtual machines, software appliances, or other processes have been identified, the cloud management system 104 can communicate with one or more the resource servers 108 to locate resources to supply the virtual machines, software appliances, or other processes. The cloud management system 104 can select resources from any of the resource servers 108 to assemble the resources needed to build the requested virtual machines, software appliances, or other processes. It may be noted that in some embodiments, permanent storage such as hard disk arrays may not be included or located within the resource servers 108 available to the cloud management system 104, because the virtual machines, software appliances, or other processes may be intended to operate on a purely transient or temporary basis. In embodiments, other hardware resources, software resources, or other resources not strictly located or hosted in the cloud can be leveraged as needed. For example, other software services that are provided outside of the cloud 102 and hosted by third parties can be invoked by in-cloud virtual machines, software appliances, or other processes. For further example, other non-cloud hardware and/or storage services can be utilized as an extension to the cloud 102, either on-demand, subscribed, or decided basis.

With the resource requirements identified, the cloud management system 104 can extract and build the virtual machines, software appliances, or other processes on a dynamic or on-demand basis. For example, a group of the resource servers 108 can respond to an instantiation request for a given quantity of processor cycles with an offer to deliver that computational power immediately and guaranteed for the next hour. A further group of the resource servers 108 can offer to immediately supply communication bandwidth, for example on a guaranteed minimum or best-efforts basis. In other embodiments, the virtual machines, software appliances, or other processes can be built on a batch basis or at a particular future time. For example, a group of the resource servers 108 can respond to a request for instantiation at a programmed time with an offer to deliver the specified quantity of processor cycles within a specific amount of time, such as the next 12 hours.

The cloud management system 104 can select a group of the resource servers 108 that match or best match the instantiation request for resources needed to build the virtual machines, software appliances, or other processes. The cloud management system 104 can then coordinate the integration of the group of the resource servers 108, to build and launch the requested virtual machines, software appliances, or other processes. The cloud management system 104 can track the integrated group of the resource servers 108, or other distributed resources that are dynamically or temporarily combined, to produce and manage the requested virtual machines, software appliances, or other processes.

In embodiments, the cloud management system 104 can generate a resource aggregation table that identifies the group of the resource servers 108 that will be used to supply the resources for the virtual machines, software appliances, or other processes. The resource servers 108 can be identified by unique identifiers such as, for instance, Internet Protocol (IP) addresses or other addresses. The cloud management system 104 can register the group of the resource servers 108 contributing to the virtual machines, software appliances, or other processes.

The cloud management system 104 can then set up and launch the initiation process for the virtual machines, software appliances, or other processes to be delivered from the cloud 102. The cloud management system 104 can for instance transmit an instantiation command or instruction to the group of the resource servers 108 providing resources to the virtual machines, software appliances, or other processes. The cloud management system 104 can receive a confirmation message back from each server in the group of the resource servers 108 indicating a status regarding the provisioning of their respective resources. Each of the resource servers 108 can confirm, for example, the availability of a dedicated amount of processor cycles, amounts of electronic memory, communications bandwidth, or applications or other software prepared to be served.

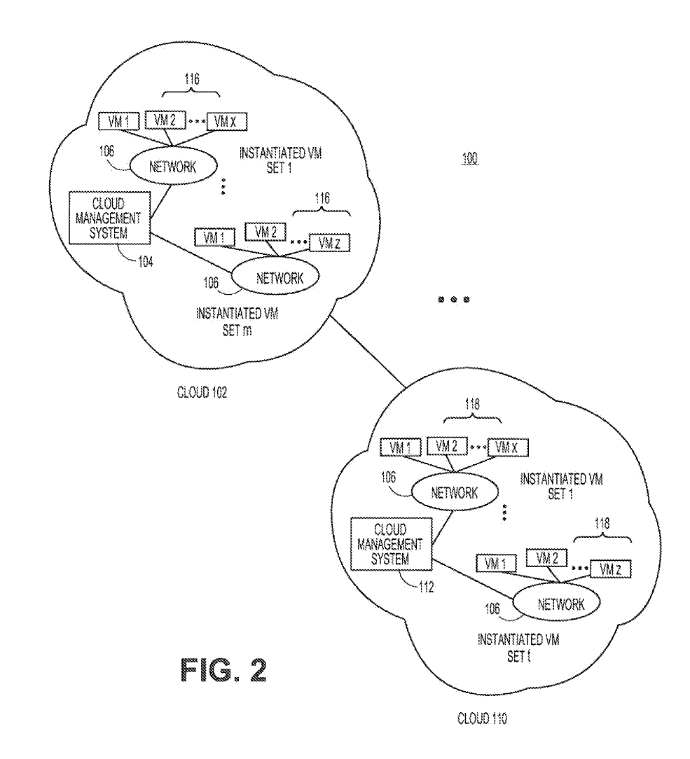

As shown for example in FIG. 2, the cloud management system 104 can then instantiate one or more than one set of virtual machines 116, software appliances (not shown), or other processes (not shown) on the resources supplied by the group of the resource servers 108. In embodiments, the cloud management system 104 can instantiate a given number, for example, 10, 500, 1000, or other number of virtual machines, software appliances, or other processes to be made available to users on a network 106, such as the Internet or other public or private network. Each virtual machine, software appliance, or other process can be assigned an instantiated machine ID that can be stored in the resource aggregation table, or other record or image of the instantiated virtual machines, software appliances, or other processes. Additionally, the cloud management system 104 can store the duration of each virtual machine, software appliance, or other process, and the collection of resources utilized by the complete set of virtual machines, software appliances, or other processes, for example as illustrated, the instantiated virtual machines 116.

In embodiments, the cloud management system 104 can further store, track and manage a user's identity and associated set of rights or entitlements to software, hardware, and other resources provided by the cloud 102. Each user that populates virtual machines, software appliances, or other processes in the cloud 102 can have specific rights and resources assigned and made available to them. The cloud management system 104 can track and configure specific actions that a user can perform, such as provision virtual machines, software appliances, or other processes with resources, configure virtual machines, software appliances, or other processes to desired specifications, submit jobs to virtual machines, software appliances, or other processes, manage other users of virtual machines, software appliances, or other processes, and other privileges or actions. The cloud management system 104 can further generate records of the usage of virtual machines, software appliances, or other processes, for example virtual machines 116, to permit tracking, billing, and auditing of the resources consumed by the user. In embodiments, the cloud management system 104 can, for example, meter the usage and/or duration of the instantiated virtual machines 116, to generate subscription billing records for a user that has requested resources for those machines. Other billing or value arrangements are possible.

The cloud management system 104 can configure each virtual machine, software appliance, or other process to be made available to users of the one or more networks 106 via a browser interface, or other interface or mechanism. Each virtual machine, software appliance, or other process can communicate with the cloud management system 104 and the resource servers 108 supporting virtual machines, software appliances, or other processes via a standard Web application programming interface (API), or via other calls or interfaces. The virtual machines, software appliances, or other processes, for example instantiated virtual machines 116, can likewise communicate with each other, as well as other sites, servers, locations, and resources available via the Internet or other public or private networks, whether within a given cloud 102 or between clouds.

It may be noted that while a browser interface or other front-end can be used to view and operate virtual machines, software appliances, or other processes, for example the virtual machines 116, from a client or terminal, the browser interface or other front-end required to view the virtual machines, software appliances, or other processes can be hosted remotely in the cloud 102. In embodiments, the virtual machines, software appliances, or other processes, for example, the virtual machines 116 or other resources may not depend on or require the user's own on-premise hardware or other resources. In embodiments, a user can therefore request and instantiate virtual machines, software appliances, or other processes on a purely off-premise basis, for instance to build and launch a virtual storefront or other application.

Because the cloud management system 104 in one regard specifies, builds, operates and manages the virtual machines, software appliances, or other processes, for example, the virtual machines 116 on a logical level, the user can request and instantiate virtual machines, software appliances, or other processes on a real-time or near real-time basis, without a need to specify or install any particular hardware. The user's virtual machines, software appliances, or other processes, such as the instantiated virtual machines 116, can be scaled up or down immediately or virtually immediately on an on-demand basis, if desired. In embodiments, the resource server 108 that are accessed by the cloud management system 104 to support the virtual machines, software appliances, or other processes can change or be substituted, over time. The type and operating characteristics of the virtual machines, software appliances, or other processes, for example the instantiated virtual machines 116, can nevertheless remain constant or virtually constant, since instances are assembled from abstracted resources that can be selected and maintained from diverse sources based on uniform specifications.

In terms of network management of the virtual machines, software appliances, or other processes, such as the instantiated virtual machines 116 that have been successfully configured and instantiated, the cloud management system 104 can perform various network management tasks including security, maintenance, and metering for billing or subscription purposes. The cloud management system 104 of a given cloud 102 can, for example, install or terminate the software and hardware resources on individual resource servers 108 or the virtual machines, software appliances, or other processes, themselves. The cloud management system 104 can monitor the virtual machines, software appliances, or other processes to detect any virus or other rogue process on individual virtual machine, software appliance, or other process, and for instance terminate the infected virtual machine, software appliance, or other process. The cloud management system 104 can likewise manage the virtual machines, software appliances, or other processes, for example, the instantiated virtual machines 116 on a collective basis, for instance, to push or deliver a software upgrade to all virtual machines, software appliances, or other processes. Other management processes are possible.

In embodiments, more than one set of virtual machines, software appliances, or other processes can be instantiated in a given cloud at the same, overlapping or successive times. The cloud management system 104 can, in such implementations, build, launch and manage multiple sets of virtual machines, software appliances, or other processes based on the same or different underlying resource servers 108, such as may be requested by different users. The cloud management system 104 can institute and enforce security protocols in a cloud 102 hosting multiple sets of virtual machines, software appliances, or other processes. Each of the individual sets of virtual machines, software appliances, or other processes can be hosted in a respective partition or sub-cloud of the resources of the cloud 102. The cloud management system 104 of the cloud 102 can for example deploy services specific to isolated or defined sub-clouds, or isolate individual virtual machines, software appliances, or other processes within the cloud to a specific sub-cloud. The subdivision of the cloud 102 into distinct transient sub-clouds or other sub-components which have assured security and isolation features can assist in establishing a multiple user or multi-tenant cloud arrangement. In a multiple user scenario, each of the multiple users can use the cloud 102 as a common utility while retaining the assurance that their information is secure from other users of the cloud 102.

In further embodiments, the sub-clouds can nevertheless be configured to share resources, if desired.

In embodiments, the virtual machines, software appliances, or other processes generated in the cloud 102 can also interact with the virtual machines, software appliances, or other processes generated in a second cloud 110. For example, as illustrated in FIG. 2, the instantiated virtual machines 116 can also interact with virtual machines 118 of the cloud 110. The cloud management system 104 of the cloud 102 can interface with the cloud management system 112 of the cloud 110, to coordinate those domains and operate the clouds and/or can also interact with on a combined basis. The cloud management system 104 of the cloud 102 can track and manage virtual machines, software appliances, or other processes instantiated in the cloud 102, as well as virtual machines, software appliances, or other processes in the cloud 110. Additionally, when instantiate the virtual machines, software appliances, or other processes, a portion of the virtual machines, software appliances, or other processes can be instantiated in the cloud 102 and a portion of the virtual machines, software appliances, or other processes can be instantiated in the cloud 110.

In the foregoing and other embodiments, the cloud 102 can offer software programs of different vendors for use by the subscribers and customers of the cloud 102. For example, the subscriber and customers can buy, lease, or utilize, under a software as a service model (SaaS), the software programs. The software programs can include any type of software such as operating systems, such as a distribution of Linux provided by Red Hat™ Corporation, and various software programs requested or typically desired by subscribers, such as middleware applications, web hosting applications, electronic mail (email) applications, and the like. The software programs can include software programs provided by different vendors, for example Red Hat™ Corporation, Oracle®, and the like. The software programs can include any type of product and/or service provided by a vendor in the cloud 102. For example, the software programs can include operating systems and/or updates to these, application programs and/or updates to these, software appliances and/or updates to these, and any combinations of operating systems, application programs and/or software appliances. The software programs can also include services provided by the vendor, for example, application services, data storage, identity management, security, communications, technical support, and/or other services. The vendors can offer the software programs in the cloud 102 under a variety of different schemes, such as offer for purchase, offer for lease, and/or offer for “on-demand” use under a subscription, for example, a Software as a Service (SaaS) model.

In the foregoing and other embodiments, the user making an instantiation request or otherwise accessing or utilizing the cloud 102 or 110 can be a person, customer, subscriber, administrator, corporation, organization, or other entity. In embodiments, the user can be or include another virtual machines, software appliances, or other processes. In further embodiments, multiple users or entities can share the use of virtual machines, software appliances, or other processes. Additionally, while the above description reference an off-premise or “public” cloud, the cloud computing environment illustrated in FIGS. 1 and 2 can be created and supported by computing resources owned and/or operated by the user in order to form a on-premise, local, or “private” cloud.

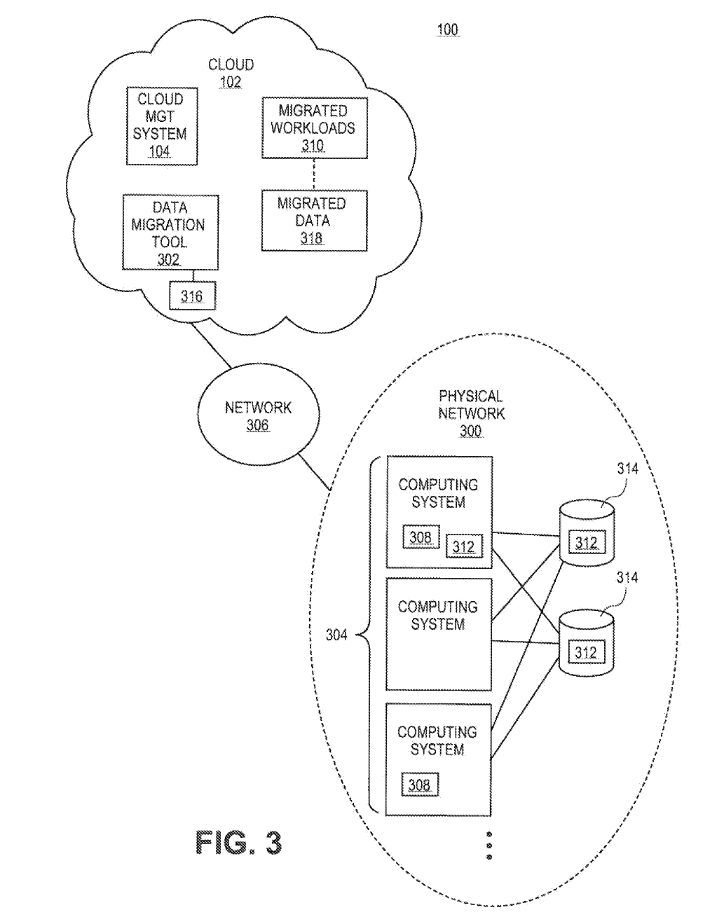

FIG. 3 illustrates an example of the cloud computing environment 100 in which workloads can be migrated to the cloud 102 from a physical network 300, and a data migration tool 302 can automatically identify and migrate data for the migrated workloads. While FIG. 3 illustrates various components of the cloud computing environment 100, one skilled in the art will realize that components can be added or removed.

As illustrated in FIG. 3, the cloud computing environment 100 can include the cloud 102. The cloud 102 can include the hardware and software resources to support virtual machines, software appliances, or other processes, as described above, including the cloud management system 104. The cloud 102 can be any type of cloud that is controlled by any type of entity. For example, the cloud 102 can be an off-premise or “public” cloud that is owned and/or operated by a public cloud vendor, such as Amazon™, Inc., in order to provide the services of the cloud to subscribers and customers. Likewise, the cloud 102 can be created and supported by computing resources owned and/or operated by an entity and/or user in order to form a on-premise, local, or “private” cloud.

In embodiments, the physically network 300 can represent the computing systems 304 owned and/or operated by an entity such as a user, a corporation, a company, a university, a governmental agency, and the like. The computing systems 304 can include any type of conventional computing system, such as a desktop, laptop, server, thin-client, tablet computer, mobile phone, personal digital assistant, mainframe, etc., that are connected by wired or wireless networks. The computing system 304 can include a number of hardware resources, such as processors, memory, network hardware and bandwidth, storage devices, etc. and a number of software resources, such as operating systems, application programs, software appliances, virtual machines, etc. Additionally, the physical network 300 can be coupled to the cloud 102 network by one or more communications networks 306. The one or more communications networks 306 can be or include the Internet, or other public or private networks. The one or more communications networks 306 can be or include wired, wireless, optical, and other network connections. One skilled in the art will realize that the one or more communications networks 306 can be any type of network, utilizing any type of communication protocol, to connect the cloud 102 and the physical network 300.

In embodiments, an entity that owns and/or operates the physical network 300 can desire to migrate one or more workloads 308 to the cloud 102. The workloads 308 can include any type of operating system, software application, software appliance, virtual machine, computing processes, and the like, that are supported by the computing systems 304. For example, the entity can desire to utilize one or more virtual machines offered by the cloud 102 and/or software offered by the cloud 102 to support the workloads 308. To migrate the workloads 308, the entity can request that the cloud management system 104 migrate the workloads 308 to the cloud 102. Likewise, the entity and/or the cloud management system 104 can utilize a workload migration tool (not shown) to migrate the workloads 308 to the cloud 102. Once migrated, the migrated workloads 310 can be supported and execute in the cloud 102 to perform functions that were previously performed in the physical network 300.

In order for the workloads to operate properly in the cloud 102 and provide the functions previously provided from the physical network 300, data 312, associated with the workloads 308, must also be migrated to the cloud 102 and associated with the migrated workloads 310. The data 312 represents information, other than the code implementing the workloads 308, that is utilized by the workloads 308 to perform their function. The data 312 can include files, databases, records, metadata, etc. utilized by the workloads 308. For example, if the workloads 308 are database applications, the data 312 can be include databases accessed by the database applications. In another example, if the workloads 308 are email programs and/or email servers, the data 312 can include contact lists, email archives, mail box folders, etc. In yet another example, if the workloads 308 are software repositories, the data 312 can include the software packages, metadata, etc. offered by the software repositories. The data 312 can be stored in any location in the physical network 300. For example, the data 312 can be stored in computer readable storage medium local to the computing system 304 and/or can be stored in other computer readable storage mediums 314 remote from the computing systems 304.

In embodiments, the data migration tool 302 can be configured to automatically identify and migrate the data 312, associated with the workloads 308, that are migrated to the cloud 102 as migrated workloads 310. The data migration tool 302 can be implemented as a software program that is configured to perform the data identification and migration as described herein. Likewise, the data migration tool 302 can be implemented as a portion of other software programs, such as the cloud management system 104 and/or workload migration tool (not shown). In either case, the data migration tool 302 can be configured to include the necessary logic, commands, instructions, and protocols to perform the processes described herein. In any implementation, the data migration tool 302 can be written in any type of conventional programming language such as C, C++, JAVA, Perl, and the like. While FIG. 3 illustrates the data migration tool 302 being executed in the cloud 102, the data migration tool 302 can be executed on any computing system in the cloud computing environment 100. For example, the data migration tool 302 can be executed on one or more of the computing systems 304.

In embodiments, to begin the identification and migration of the data 312, the data migration tool 302 can be configured to receive a request to migrate the data 312. The data migration tool 302 can receive the request prior to, simultaneously with, or subsequent to the migration of the workloads 308. The request can include an identification of the workloads 308 being migrated and details of the workloads 308 being migrated. The identification and the details allows the data migration tool 302 to locate and access the workloads 308 in order to identify and migrate the data 312 associated with the workloads 308. For example, the identification can include a specific identification of the workloads 308 such as the specific instances of the software applications, software appliances, virtual machines, etc. that are being migrated. The details can include other information describing the workloads 308, such as type of software application, software appliances, virtual machines, identification of the computing systems 304 supporting the workloads 308, location of the code implementing the workloads, access information for accessing the workloads (e.g. login and password).

The data migration tool 302 can be configured to receive the request from the cloud management system 104 and/or workload migration tool (not shown). To achieve this, the data migration tool 302 can be configured to include the necessary logic, commands, instructions, and protocols to communicate with the cloud management system 104, and/or the workload migration tool (not shown). Likewise, the data migration tool 302 can be configured to receive the request from the entity and/or a user associated with the physical network 300. To achieve this, the data migration tool 302 can be configured to include the necessary logic, commands, instructions, and protocols to communicate with the entity and/or user via command line interfaces, graphical user interfaces (GUIs), and/or other communications channels such as email.

Once the request is received, the data migration tool 302 can be configured to identify the data 312 and the location of the data 312 in the physical network 300. The data migration tool 302 can be configured to identify the types of data 312, for example, type of file extension utilized by the workloads 308, and/or to identify specific data 312, for example, the data 312 with a specific name or label and location. The location of the data 312 can be the physical or logical address of the computer readable storage medium storing the data 312, such as drive name, path, etc.

To identify the data 312 and the location of the data 312, the data migration tool 302 can be configured to examine the workloads 308 to determine the data 312 that is associated with the workloads 308 and the location of the data 312. For example, the data migration tool 302 can be configured to examine configuration information of the workloads 308 to identify the data 312 referenced or used by the workloads 308 and the location of the data 312. To achieve this, the data migration tool 302 can be configured to include the necessary logic, commands, instructions, and protocols to communicate with and access the workloads 308 and examine the configuration information of the workloads 308.

Additionally, to identify the data 312 that is associated with the workloads 308, the data migration tool 302 can be configured to maintain a standard configuration record 316. The standard configuration record 316 can be any type of searchable data record system (e.g. database) that is capable of storing information about the known types of workloads 308, such as format of the configuration information of the known types of workloads 308 and the common types of the data 312 utilized by the known types of workloads 308. For example, the standard configuration record 316 can include records of known software programs, software appliances, etc. and the format of the configuration information and the common type of the data 312 utilized by the known types of workloads 308. To generate and utilize the standard configuration record 316, the data migration tool 302 can be configured to include the necessary logic, commands, instructions, and protocols to generate the standard configuration record 316, store data in the standard configuration record 316, search the standard configuration record 316, and extract data from the standard configuration record 316. The data migration tool 302 can be configured to store the standard configuration record 316 in computer readable storage devices or media (CD, DVD, hard drive, portable storage memory, etc.) whether associated with the cloud 102 or remotely located.

The data migration tool 302 can be configured to utilize the standard configuration record 316 to access the workloads 308 and configuration information of the workloads 308. Likewise, the data migration tool 302 can be configured to utilize the types of the data 312, contained in the standard configuration record 316 and/or identified from accessing the workloads 308, to search the physical network 300. The data migration tool 302 can be configured to search the physical network 300, e.g. the computing systems 304 and/or the computer readable storage media 314, to identify the data 312 associated with the workloads 308 and the location of the data 312.

Once the data 312 that is associated with the workloads 308 and the location of the data 312 is identified, the data migration tool 302 can be configured to automatically extract the data from the physical network 300. The data migration tool 302 can be configured to access the computing systems 304 and the computer readable storage media 314, via the one or more networks 306, to locate and retrieve the data 312. To achieve this, the data migration tool 302 can be configured to include the necessary logic, commands, instructions, and protocols to communicate with and access the computing systems 304 and the computer readable storage media 314 via the one or more networks 306. Likewise, the data migration tool 302 can be configured to include the necessary logic, commands, instructions, and protocols to establish a secure communications link with the computing systems 304 and the computer readable storage media 312 utilizing any type of known symmetric and/or asymmetric encryption algorithms.

Once the data 312 is extracted, the data migration tool 302 can be configured to store the data 312 in the cloud 102 as migrated data 318. The data migration tool 302 can be configured to store the migrated data 318 so that the migrated data 318 is associated with the migrated workloads 310. The data migration tool 302 can be configured to create (and/or communicate with the cloud management system 104 to create) a storage location in the cloud 102 for the migrated data 318. To associate the migrated data with the migrated workloads 310, the data migration tool 302 can be configured to modify the configuration of the migrated workloads 310 to reference the storage location of the migrated data 318. Likewise, without modifying the configuration, the data migration tool 302 can be configured to create (and/or communicate with the cloud management system 104 to create) a storage location that emulates the location where the data 312 was stored in the physical network 300. For example, the data migration tool 302 can be create a storage location for the migrated data 318 that has the same drive and/or path name. As such, the storage location of the migrated data 318 would appear the same as the location of the data 312 in the physical network 300.

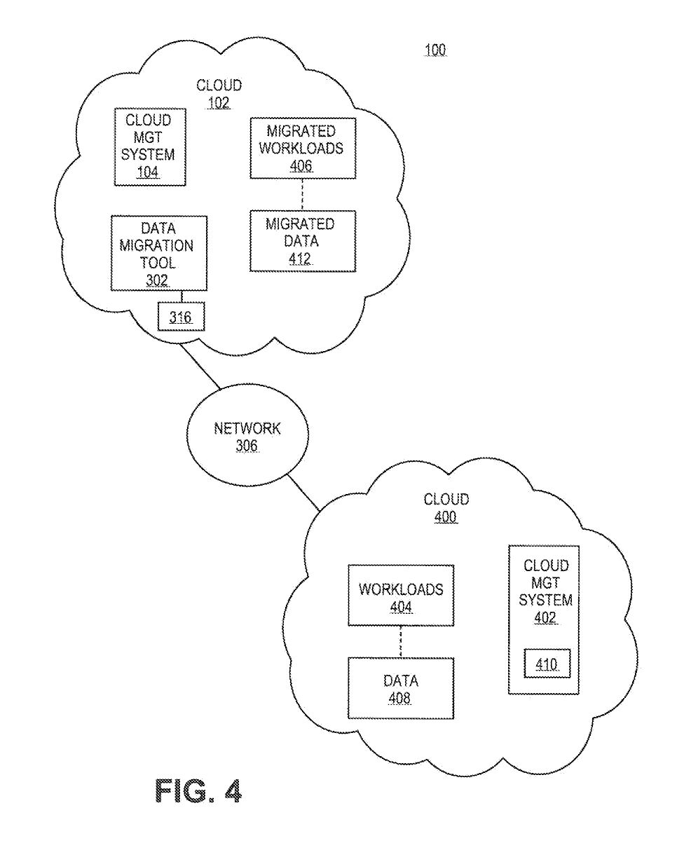

Accordingly to embodiments, the data migration tool 302 can migrate data for workloads that are migrated between different cloud networks. FIG. 4 illustrates another example of the cloud computing environment 100 in which workloads can be migrated to the cloud 102 from another cloud 400, and the data migration tool 302 can automatically identify and migrate data for the migrated workloads. While FIG. 4 illustrates various components of the cloud computing environment 100, one skilled in the art will realize that components can be added or removed.

As illustrated in FIG. 4, the cloud computing environment 100 can include the cloud 400 in addition to the cloud 102. The cloud 400 can include the hardware and software resources to support virtual machines, software appliances, or other processes, as described above, including a cloud management system 402. The cloud 400 can be any type of cloud that is controlled by any type of entity. For example, the cloud 400 can be an off-premise or “public” cloud that is owned and/or operated by a public cloud vendor, such as Amazon™, Inc., in order to provide the services of the cloud to subscribers and customers. Likewise, the cloud 400 can be created and supported by computing resources owned and/or operated by an entity and/or user in order to form a on-premise, local, or “private” cloud.

In embodiments, an entity that owns and/or operates the cloud 400 or utilizes the cloud 400 can desire to migrate one or more workloads 404 to the cloud 102. The workloads 404 can include any type of operating system, software application, software appliance, virtual machine, computing processes, and the like, that are supported by the computing resources of the cloud 400. For example, the entity can desire to utilize one or more virtual machines offered by the cloud 102 and/or software offered by the cloud 102 to support the workloads 404. To migrate the workloads 404, the entity can request that the cloud management system 104 and/or the cloud management system 402 migrate the workloads 404 to the cloud 102. Likewise, the entity, the cloud management system 104, and/or the cloud management system 402 can utilize a workload migration tool (not shown) to migrate the workloads 404 to the cloud 102. Once migrated, the migrated workloads 406 can be supported and execute in the cloud 102 to perform functions that were previously performed in the cloud 400.

In order for the workloads 404 to operate properly in the cloud 102 and provide the functions previously provided from the cloud 400, data 408, associated with the workloads 404, must also be migrated to the cloud 102 and associated with the migrated workloads 406. The data 408 represents information, other than the code implementing the workloads 404, that is utilized by the workloads 404 to perform their function. The data 408 can include files, databases, records, metadata, etc. utilized by the workloads 404.

In embodiments, the data migration tool 302 can be configured to automatically identify and migrate the data 408, associated with the workloads 404, that are migrated to the cloud 102 as migrated workloads 406. While FIG. 3 illustrates the data migration tool 302 being executed in the cloud 102, the data migration tool 302 can be executed on any computing system in the cloud computing environment 100. For example, the data migration tool 302 can be supported and executed in the cloud 400.

In embodiments, to begin the identification and migration of the data 408, the data migration tool 302 can be configured to receive a request to migrate the data 408. The data migration tool 302 can receive the request prior to, simultaneously with, or subsequent to the migration of the workloads 404. The request can include an identification of the workloads being migrated and details of the workloads 404 being migrated. The identification and the details allows the data migration tool 302 to locate and access the workloads 404 in order to identify and migrate the data 408 associated with the workloads 404. For example, the identification can include a specific identification of the workloads 404 such as the specific instances of the software applications, software appliances, virtual machines, etc. that are being migrated. The details can include other information describing the workloads 404, such as type of software application, software appliances, virtual machines, identification of the computing resources of the cloud 400 supporting the workloads 404, location of the code implementing the workloads, access information for accessing the workloads (e.g. login and password).

The data migration tool 302 can be configured to receive the request from the cloud management system 104, the cloud management system 402 and/or workload migration tool (not shown). Likewise, the data migration tool 302 can be configured to receive the request from the entity and/or a user associated with the cloud 400.

Once the request is received, the data migration tool 302 can be configured to identify the data 408 and the location of the data 408 in the cloud 400. The data migration tool 302 can be configured to identify the types of data 400, for example, type of file extension utilized by the workloads 404, and/or to identify specific data 408, for example, the data 408 with a specific name or label and location. The location of the data 408 can be the physical or logical address of the computer readable storage medium storing the data 408, such as drive name, path, etc.

To identify the data 408 and the location of the data 408, the data migration tool 302 can be configured to examine the workloads 404 to determine the data 408 that is associated with the workloads 404 and the location of the data 408. For example, the data migration tool 302 can be configured to examine configuration information of the workloads 404 to identify the data 408 referenced or used by the workloads 404 and the location of the data 408. Additionally, to identify the data 408 that is associated with the workloads 404, the data migration tool 302 can be configured to maintain the standard configuration record 316. The data migration tool 302 can be configured to utilize the standard configuration record 316 to access the workloads 404 and configuration information of the workloads 404. Likewise, the data migration tool 302 can be configured to utilize the types of the data 408, contained in the standard configuration record 316 and/or identified from accessing the workloads 404, to search the cloud 400. The data migration tool 302 can be configured to search the cloud 400 to identify the data 408 associated with the workloads 404 and the location of the data 408.

Additionally, the data migration tool 302 can be configured to communicate with the cloud management system 402 to identify the data 408 and the location of the data 408. The cloud management system 402 can be configured to maintain a inventory record 410 that contains a record of all workloads supported by the cloud and the data associated with the workload. The data migration tool 302 can be configured to search (and/or request that the cloud management system 402 search) the inventory record 410 to identify the data 408 that is associated with the workloads 404.

Once the data 408 that is associated with the workloads 404 and the location of the data 408 is identified, the data migration tool 302 can be configured to automatically extract the data from the cloud 400. The data migration tool 302 can be configured to access the cloud 400, via the one or more networks 306, to locate and retrieve the data 408. To achieve this, the data migration tool 302 can be configured to include the necessary logic, commands, instructions, and protocols to communicate with and access the cloud 400 via the one or more networks 306, for example, using any access information required to access the cloud 400. Likewise, the data migration tool 302 can be configured to include the necessary logic, commands, instructions, and protocols to establish a secure communications link with the cloud 400 utilizing any type of known symmetric and/or asymmetric encryption algorithm. Likewise, the data migration tool 302 can request that the cloud management system 402 provide the data 408.

Once the data 408 is extracted, the data migration tool 302 can be configured to store the data 408 in the cloud 102 as migrated data 412. The data migration tool 302 can be configured to store the migrated data 412 so that the migrated data 412 is associated with the migrated workloads 406. The data migration tool 302 can be configured to create (and/or communicate with the cloud management system 104 to create) a storage location in the cloud 102 for the migrated data 412. To associate the migrated data with the migrated workloads 406, the data migration tool 302 can be configured to modify the configuration of the migrated workloads 406 to reference the storage location of the migrated data 412. Likewise, without modifying the configuration, the data migration tool 302 can be configured to create (and/or communicate with the cloud management system 104 to create) a storage location that emulates the location where the data 408 was stored in the cloud 400. For example, the data migration tool 302 can be create a storage location for the migrated data 412 that has the same drive and/or path name. As such, the storage location of the migrated data 412 would appear the same as the location of the data 408 in the cloud 400.

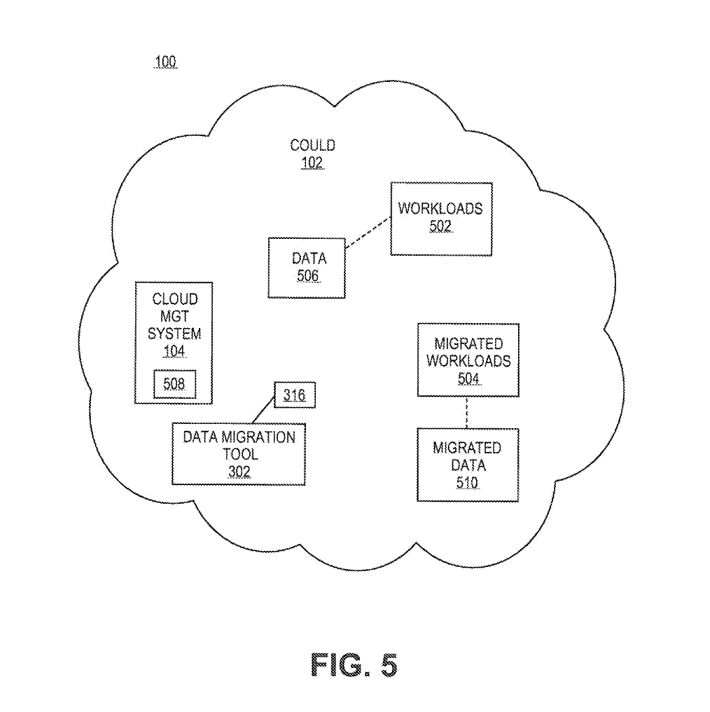

In the exemplary embodiments described above, the data migration tool 302 can be utilized to migrate data between separate network. The data migration tool 302 can also be configured to migrate data within the cloud 102. FIG. 5 illustrates an example of the cloud computing environment 100 in which workloads can be migrated within the cloud 102, and a data migration tool 302 can automatically identify and migrate data for the migrated workloads. While FIG. 5 illustrates various components of the cloud computing environment 100, one skilled in the art will realize that components can be added or removed.

In embodiments, an entity that utilizes the cloud 102 and/or operates the cloud 102 can desire to migrate one or more workloads 502 within the cloud 102. The workloads 502 can include any type of operating system, software application, software appliance, virtual machine, computing processes, and the like, that are supported by the cloud 502. For example, the entity can desire to upgrade or change the virtual machines offered by the cloud 102 and/or software offered by the cloud 102 to support the workloads 502. To migrate the workloads, the entity can request that the cloud management system 104 migrate the workloads 502 within the cloud 102. Likewise, the entity and/or the cloud management system 104 can utilize a workload migration tool (not shown) to migrate the workloads 502 within the cloud 102. Once migrated, the migrated workloads 504 can be supported and execute in the cloud 102 to perform functions that were previously performed.

In order for the workloads to operate properly in the cloud 102 and provide the functions previously provided, data 506, associated with the workloads 502, may also be migrated within the cloud 102 and associated with the migrated workloads 504. The data 506 can be stored in any location in the cloud 102. In embodiments, the data migration tool 302 can be configured to automatically identify and migrate the data 506, associated with the workloads 502, that are migrated within the cloud 102 as migrated workloads 504. While FIG. 5 illustrates the data migration tool 302 being executed in the cloud 102, the data migration tool 302 can be executed on any computing system in the cloud computing environment 100.

In embodiments, to begin the identification and migration of the data 506, the data migration tool 302 can be configured to receive a request to migrate the data 506. The data migration tool 302 can receive the request prior to, simultaneously with, or subsequent to the migration of the workloads 502. The request can include an identification of the workloads being migrated and details of the workloads 502 being migrated. The identification and the details allows the data migration tool 502 to locate and access the workloads 502 in order to identify and migrate the data 506 associated with the workloads 502. For example, the identification can include a specific identification of the workloads 502 such as the specific instances of the software applications, software appliances, virtual machines, etc. that are being migrated. The details can include other information describing the workloads 502, such as type of software application, software appliances, virtual machines, identification of the computing resources of the cloud 102 supporting the workloads 502, location of the code implementing the workloads, access information for accessing the workloads (e.g. login and password).

The data migration tool 302 can be configured to receive the request from the cloud management system 104 and/or workload migration tool (not shown). Likewise, the data migration tool 302 can be configured to receive the request from the entity and/or a user associated the cloud 102.

Once the request is received, the data migration tool 302 can be configured to identify the data 506 and the location of the data 506 in the cloud 102. The data migration tool 302 can be configured to identify the types of data 506, for example, type of file extension utilized by the workloads 502, and/or to identify specific data 506, for example, the data 506 with a specific name or label and location. The location of the data 506 can be the physical or logical address of the computer readable storage medium storing the data 506, such as drive name, path, etc.

To identify the data 506 and the location of the data 506, the data migration tool 302 can be configured to examine the workloads 502 to determine the data 506 that is associated with the workloads 502 and the location of the data 506. For example, the data migration tool 302 can be configured to examine configuration information of the workloads 502 to identify the data 506 referenced or used by the workloads 502 and the location of the data 506. Additionally, to identify the data 506 that is associated with the workloads 502, the data migration tool 302 can be configured to maintain the standard configuration record 316. The data migration tool 302 can be configured to utilize the standard configuration record 316 to access the workloads 502 and configuration information of the workloads 502. Likewise, the data migration tool 302 can be configured to utilize the types of the data 506, contained in the standard configuration record 316 and/or identified from accessing the workloads 502, to search the cloud 102. The data migration tool 302 can be configured to search the cloud 102 to identify the data 506 associated with the workloads 502 and the location of the data 506.

Additionally, the data migration tool 302 can be configured to communicate with the cloud management system 104 to identify the data 506 and the location of the data 506. The cloud management system 104 can be configured to maintain a inventory record 508 that contains a record of all workloads supported by the cloud 102 and the data associated with the workload. The data migration tool 302 can be configured to search (and/or request that the cloud management system 104 search) the inventory record 508 to identify the data 506 that is associated with the workloads 502.

Once the data 506 that is associated with the workloads 502 and the location of the data 506 is identified, the data migration tool 302 can be configured to automatically relocate the data 506 within the cloud 102 as migrated data 510. The data migration tool 302 can be configured to store the migrated data 510 so that the migrated data 510 is associated with the migrated workloads 504. The data migration tool 302 can be configured to create (and/or communicate with the cloud management system 104 to create) a storage location in the cloud 102 for the migrated data 510. To associate the migrated data 510 with the migrated workloads 504, the data migration tool 302 can be configured to modify the configuration of the migrated workloads 504 to reference the storage location of the migrated data 510. Likewise, without modifying the configuration, the data migration tool 302 can be configured to create (and/or communicate with the cloud management system 104 to create) a storage location that emulates the location where the data 506 was stored in the cloud 102. For example, the data migration tool 302 can be create a storage location for the migrated data 510 that has the same drive and/or path name. As such, the storage location of the migrated data 510 would appear the same as the location of the data 506 in the cloud 102.

While the above exemplary embodiments describes data being migrated into the cloud 102, the data migration tool 302 can be configured to migrate data out of the cloud 102 utilizing the processes described above.

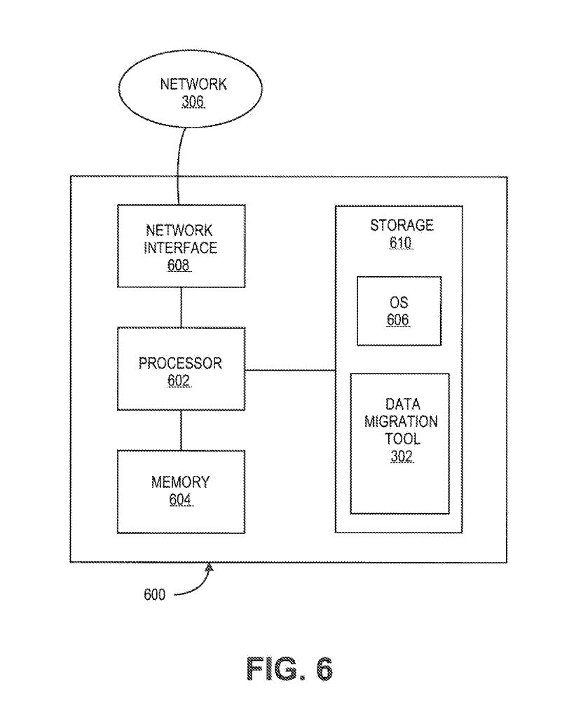

FIG. 6 illustrates an exemplary diagram of a computing system 600, which can implement the data migration tool 302, and configured to communicate with the one or more communications networks 306, according to embodiments. The computing system 600 can represent any one of the computing systems contained in the cloud network 102, the cloud network 400, and/or the physical network 300. In embodiments as shown, the computing system 600 can comprise a processor 602 communicating with a memory 604, such as electronic random access memory, operating under control of or in conjunction with operating system 606. The operating system 606 can be, for example, a distribution of the Linux™ operating system, such as SELinux, the Unix™ operating system, or other open-source or proprietary operating system or platform. The processor 602 also communicates with one or more computer readable storage media or devices 610, such as hard drives, optical storage, and the like, which can store the application program embodiment of the data migration tool 302. The processor 602 further communicates with a network interface 608, such as an Ethernet or wireless data connection, which in turn communicates with one or more communications networks 306, such as the Internet or other public or private networks.

The processor 602 also communicates with the application program embodiment of the data migration tool 302 to execute control logic and allow for the processes as described above and below. Other configurations of the computing system 600, associated network connections, and other hardware and software resources are possible.

While FIG. 6 illustrates the computing system 600 as a standalone system including a combination of hardware and software, the computing system 600 can include multiple systems operating in cooperation. The application program embodiment of the data migration tool 302 can be implemented as a software application program capable of being executed by the computing system 600, as illustrated, or other conventional computer platforms. Likewise, the data migration tool 302 can also be implemented as a software module or program module capable of being incorporated in other software application programs, such as the cloud management system 104 and/or workload migration tool (not shown). In either case, the data migration tool 302 can be implemented in any type of conventional proprietary or open-source computer language. When implemented as a software application program or program code, the data migration tool 302 can be stored in a computer readable storage medium or device, such as storage 610 accessible by the computing system 600. Likewise, during execution, a copy of the data migration tool 302 can be stored in the memory 604.

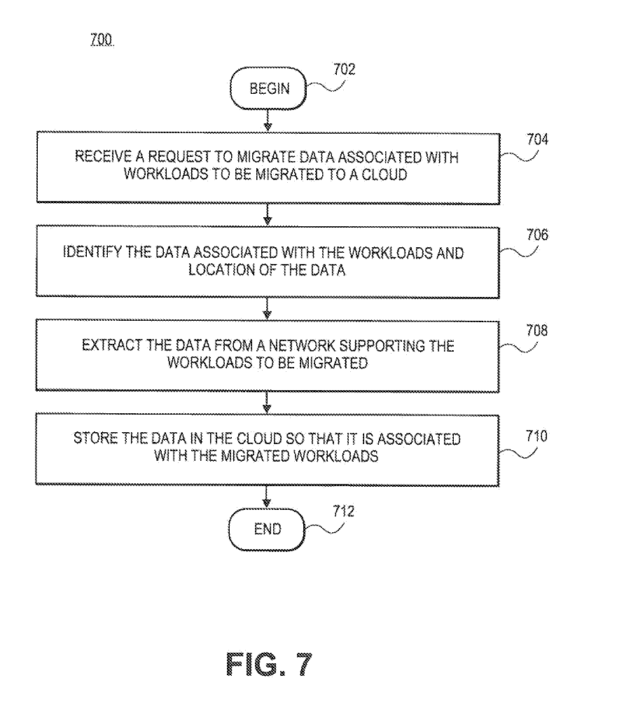

FIG. 7 illustrates a flow diagram of an exemplary process 700 for migrating data that is associated with workloads that are migrated into or within a cloud, according to various embodiments. In 702, processing can begin.

In 704, the data migration tool 302 can receive a request to migrate data that is associated with workloads that are migrated into or within a cloud 102. The data migration tool 302 can receive the request from an entity and/or a user that is associated with the workloads being migrated. Likewise, the data migration tool 302 can receive the request from an entity, user, and/or system that is associated with the cloud 102, such as cloud management system 104. The data migration tool 302 can be received prior to, simultaneously with, or subsequent to migrating the workloads to or within the cloud 102. The request can include any information related to the workloads being migrated so that the data migration tool 302 can identify the data associated with the workloads to be migrated.

In 706, the data migration tool 302 can automatically identify the data to be migrated and locations of the data. The data migration tool 302 can examine the configuration of the workloads being migrated to identify the data to be migrated and the locations of the data. Likewise, the data migration tool 302 can be search the network supporting the workload to be migrated for the data utilized by the workloads to be migrated. Additionally, if the workloads are supported by a cloud, the data migration tool 302 can communicate with a cloud management system to identify the data and the locations of the data.

In 708, the data migration tool 302 can automatically extract the data from the network supporting the workloads to be migrated. The data migration tool 302 can extract the data via a communications network coupled to the network hosting the workloads to be migrated to the cloud 102. Likewise, if the data is supported by a cloud, the data migration tool 302 can request that a cloud management system provide the data to be migrated.

In 710, the data migration tool 302 can store the migrated data so that it is associated with the migrated workloads. The data migration tool 302 can create (and/or cooperate with the cloud management system 104 to create) a storage locations in the cloud 102 for the migrated data. The data migration tool 302 can modify the configuration of the migrated workloads to reference the migrated data. Likewise, the data migration tool 302 can create (and/or cooperate with the cloud management system 104 to create) the storage locations in the cloud 102 for the migrated data that emulates the locations of the data in network that originally hosted the workloads.

In 712, the process can end, but the process can return to any point and repeat.

Certain embodiments may be performed as a computer application program. The computer application program may exist in a variety of forms both active and inactive. For example, the application program can exist as software program(s) comprised of program instructions in source code, object code, executable code or other formats; firmware program(s); or hardware description language (HDL) files. Any of the above can be embodied on a computer readable medium, which include computer readable storage devices and media, and signals, in compressed or uncompressed form. Exemplary computer readable storage devices and media include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present teachings can be configured to access, including signals downloaded through the Internet or other networks. Concrete examples of the foregoing include distribution of executable software application program(s) on a CD-ROM or via Internet download. In a sense, the Internet itself, as an abstract entity, is a computer readable medium. The same is true of computer networks in general.

While the aspects have been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Furthermore, to the extent that the terms “including”, “includes”, “having”, “has”, “with”, or variants thereof are used in either the detailed description and the claims, such terms are intended to be inclusive in a manner similar to the term “comprising.” As used herein, the terms “one or more of” and “at least one of” with respect to a listing of items such as, for example, A and B, means A alone, B alone, or A and B. Those skilled in the art will recognize that these and other variations are possible within the spirit and scope as defined in the following claims and their equivalents.

What is claimed is:

1. A method for migrating information in a cloud computing environment, comprising:
identifying, automatically, data and an existing location of the data that is associated with a workload being migrated into a cloud network, wherein the data is stored at the existing location on a computer system;
extracting, automatically, the data from the computer system; and
storing the data in the cloud network, wherein the data that is stored in the cloud network is associated with the workload migrated into the cloud network.

2. The method of claim 1, the method further comprising:
receiving, prior to identifying the data, a request to migrate the data that comprises an identification of the workload.

3. The method of claim 2, wherein the request is received from at least one of a user, a workload migration tool, and a cloud management system.

4. The method of claim 1, wherein identifying the data and the existing location of the data, comprises:
examining a configuration of the workload to identify the data and the existing location of the data.

5. The method of claim 4, wherein identifying the data and the existing location of the data, further comprises:
searching a record of standard configurations to identify a format of the configuration of the workload.

6. The method of claim 1, wherein storing the data in the cloud network, comprises:
storing the data in a location in the cloud network that emulates the existing location of the data.

7. A computer readable storage medium comprising instructions for causing a processing system to perform the method of claim 1.

8. An apparatus, comprising:
a memory storing instructions; and
a processor configured to execute the instructions to perform the method of claim 1.

9. A method for migrating information in a cloud computing environment, comprising:
identifying, automatically, data and an existing location of the data that is associated with a workload being migrated from a first cloud network to a second cloud network, wherein the data is stored at the existing location in the first cloud network;
extracting, automatically, the data from the first cloud network; and
storing the data in the second cloud network, wherein the data that is stored in the second cloud network is associated with the workload migrated into the second cloud network.

10. The method of claim 9, the method further comprising:
receiving, prior to identifying the data, a request to migrate the data that comprises an identification of the workload.

11. The method of claim 10, wherein the request is received from at least one of a user, a workload migration tool, a cloud management system of the first cloud network, and a cloud management system of the second cloud network.

12. The method of claim 9, wherein identifying the data and the existing location of the data, comprises:
examining a configuration of the workload to identify the data and the existing location of the data.

13. The method of claim 12, wherein identifying the data and the existing location of the data, further comprises:
searching a record of standard configurations to identify a format of the configuration of the workload.

14. The method of claim 9, wherein identifying the data and the existing location of the data, comprises:
communicating with a cloud management system of the second cloud network to identify the data and the location of the data.

15. The method of claim 9, wherein storing the data in the second cloud network, comprises:
storing the data in a location in the second cloud network that emulates the existing location of the data in the first cloud network.

16. The method of claim 9, wherein storing the data in the second cloud network, comprises:
storing the data in a location in the second cloud network; and
modifying a configuration of the workload, migrated into the second cloud network, to reference the location in the second cloud network.

17. A computer readable storage medium comprising instructions for causing a processing system to perform the method of claim 9.

18. An apparatus, comprising:
a memory storing instructions; and
a processor configured to execute the instructions to perform the method of claim 9.

19. A method for migrating information in a cloud computing environment, comprising:
identifying, automatically, data and an existing location of the data that is associated with a workload being migrated internally within a cloud network, wherein the data is stored at the existing location in the first cloud network; and
relocating, automatically, the data to a new location in the cloud network, wherein the data is associated with the workload migrated within the cloud network.

20. The method of claim 19, wherein relocating the data comprises:
modifying a configuration of the workload, within the cloud network, to reference the new location in the cloud network.
